(19) United States
(12) Patent Application Publication
(10) Pub. No.: US 2005/0008346 A1
(43) Pub. Date: Jan. 13, 2005

(54) Recording apparatus, method for controlling the same and playback apparatus

(75) Inventors: Tadashi Noguchi, Tokorozawa-shi (JP); Takakazu Sugiyama, Tokorozawa-shi (JP); Hiroshi Otsubo, Tokorozawa-shi (JP); Michitaka Fujita, Tokorozawa-shi (JP); Takahide Okamoto, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/679,430

(22) Filed: Oct. 7, 2003

(30) Foreign Application Priority Data
Oct. 7, 2002 (JP) P2002-294307

(51) Int. Cl. H04N 5/781

(52) U.S. Cl. 386/125; 386/126

(57) ABSTRACT

A recording apparatus comprises a recording device, a changing device, a storage device and a control device. The recording device records recording data on a recording medium. The changing device receives a plurality of recording media supplied from an outside, selects one of the plurality of recording media as received and replaces the first recording medium loaded in the recording device with the second recording medium as selected. The storage device stores, during replacement of the first recording medium, the recording data recorded thereon. The control device controls the recording device and the changing device, monitors a remaining recording capacity or recording time of the first recording medium during recording, causes the first recording medium to be replaced based on monitoring results, and reads, after completion of the replacement of the first recording medium, the recording data of the first recording medium from the storage device and records same on the second recording medium.

### BACKGROUND OF THE INVENTION

1. Field of the Invention

The present invention relates to techniques for recording and reproducing data.

2. Description of the Related Art

The conventional video disc recorder receives a single disc in the main units and records or reproduces video images to or from the disc. The video disc recorder operates in two operational modes, that is, a standard mode for recording/reproduction of two-hour data and a long play mode for recording/reproduction of six-hour data. Therefore, the recording/reproduction time has been limited to six hours.

### SUMMARY OF THE INVENTION

In the case of recording a program in excess of six hours using the conventional video disc recorder, when a disc is fully recorded, the user has to suspend recording of the program and replace the disc with a new one to continue the recording. Thus, there are problems in that the recorded program has a blank because of the replacement and the user's operation is needed to replace the disc with a new one.

An object of the invention is to solve the problems described above.

According to an aspect of the present invention, there is provided a recording apparatus, comprising: a recording device for recording recording data on a recording medium; a changing device for receiving a plurality of recording media supplied from an outside, selecting one of the plurality of recording media as received and replacing a first recording medium loaded in the recording device with a second recording medium as selected; a storage device for storing, during replacement of the first recording medium, the recording data recorded thereon; and a control device for controlling the recording device and the changing device, monitoring a remaining recording capacity or recording time of the first recording medium during recording, causing the first recording medium to be replaced based on monitoring results, and reading, after completion of the replacement of the first recording medium, the recording data of the first recording medium from the storage device and recording same on the second recording medium.

According to another aspect of the present invention, there is provided a recording apparatus, which records one or more pieces of recording data on one recording medium selected among from a plurality of recording media supplied from an outside, and enables, when the recording medium has no available recording space, an update recording to be performed to conduct overwriting with new recording data in a recording area in which the recording data have currently been recorded, said recording apparatus comprising: a recording device for recording the recording data on a recording medium; a changing device for receiving a plurality of recording media supplied from an outside, selecting one of the plurality of recording media as received and replacing a first recording medium loaded in the recording device with a second recording medium as selected; an input device for outputting a signal in accordance with a user's operation; and a control device for generating, based on the signal output from the input device, update recording information for specifying a recording medium, which allows update recording, in the plurality of recording media as received, determining, based on the update recording information, whether the recording medium being currently recorded is allowed to be subjected to the update recording, and controlling, when allowed, the recording device to perform the update recording on the recording medium.

According to further another aspect of the present invention, there is provided a recording apparatus, which records one or more pieces of recording data on one recording medium selected among from a plurality of recording media supplied from an outside, and enables, when the recording medium has no available recording space, an update recording to be performed to conduct overwriting with new recording data in a recording area in which the recording data have currently been recorded, said recording apparatus comprising: a recording device for recording the recording data on a recording medium; a changing device for receiving a plurality of recording media supplied from an outside, selecting one of the plurality of recording media as received and replacing a first recording medium loaded in the recording device with a second recording medium as selected; an input device for outputting a signal in accordance with a user's operation; and a control device for generating, based on the signal output from the input device, set-specification information for specifying recording media which constitute a set of recording media in the plurality of received recording media, generating update recording information for specifying a recording medium which allows update recording, in the plurality of recording media as received, controlling the recording device and the changing device based on the set-specification information to record a part of the recording data on one of the set of recording media, and then continuously recording another part of the recording data, which follows said part of the recording data, on another recording medium of the set of recording media, controlling, when all of the set of recording media have no available recording space, the recording device and the changing device based on the update recording information to specify a recording medium, which allows update recording, in said set of recording media, and conducting overwriting with new recording data in a recording area of said recording medium as specified, in which the recording data have currently been recorded.

According to further another aspect of the present invention, there is provided a recording apparatus, which comprises: a recording device for recording recording data on a recording medium; a changing device for receiving a plurality of recording media supplied from an outside, selecting one of the plurality of recording media as received and replacing a first recording medium loaded in the recording device with a second recording medium as selected; an input device for outputting a signal in accordance with a user's operation; and a control device for generating, based on the signal output from the input device, category information that indicates a category of the recording data to be recorded on each of the recording media as received and controlling the recording device to record the category information on the recording media.

According to further another aspect of the present invention, there is provided a reproducing apparatus that enables sequential reproduction of image data from a plurality of recording media in which a sequence of divided image data and management information which specifies an order of reproduction have been recorded, comprising: a reproducing device for reproducing the image data and the management information from a recording medium of the plurality of recording media; a changing device for receiving the plurality of recording media supplied from an outside, selecting one of the plurality of recording media as received and replacing a first recording medium loaded in the recording device with a second recording medium as selected; an input device for outputting a signal in accordance with a user's operation; and a control device for controlling, when there is made a detection of specification of the sequential reproduction, the changing device and the reproducing device based on the signal output from the input device, to reproduce sequentially the recording media in the reproduction order, which is specified by the management information reproduced from the plurality of recording media as received.

According to further another aspect of the present invention, there is provided a method for controlling a recording apparatus, said recording apparatus that has an input device for outputting a signal in accordance with a user's operation and enables recording data to be dividedly recorded on recording media on which a set-specification information for specifying a set of recording media to be subjected to a sequential recording has previously been recorded, said method comprising: a step of reading the set-specification information from a plurality of recording media supplied from an outside; a step of displaying an image for prompting specification of the set of recording media to be subjected to the sequential recording, based on the set-specification information as read; and a step of recording, after the set of recording media to be subjected to the sequential recording is specified by the input device, recording a part of the recording data on one of the set of recording media, and then continuously recording another part of the recording data, which follows said part of the recording data, on another recording medium of the set of recording media.

According to further another aspect of the present invention, there is provided a method for controlling a recording apparatus, said recording apparatus that has an input device for outputting a signal in accordance with a user's operation and enables to record recording data on a recording medium in which there has previously been recorded an update recording information, which allows, when there is no available recording space, an update recording to be performed to conduct overwriting with new recording data in a recording area in which the recording data have currently been recorded, said method comprising: a step of reading the update recording information from a plurality of recording media supplied from an outside; a step of displaying an image that indicates recording media of the plurality of recording media as received, which allow the update recording to be performed and prompts specification of a recording medium to be subjected to recording, based on the update recording information as read; and a step of overwriting, after the recording medium to be subjected to the recording is specified by the input device, a recording area in which the recording data has first been recorded, with new recording data when the recording medium has no available recording space, in case where the recording medium as specified allows update recording.

According to further another aspect of the present invention, there is provided a method of controlling a recording apparatus, said recording apparatus that has an input device for outputting a signal in accordance with a user's operation and enables recording data to be selectively recorded on a recording medium on which a category information, which indicates a category of a recorded content, has previously recorded, said method comprising: a step of reading the category information from a plurality of recording medium supplied from an outside; a step of displaying the category of the recorded content based on the category information as read and prompting specification of a category of recording data to be recorded; and a step of selecting, after the category is specified by the input device, a recording medium with the same category as the specified one and recording the recording data on the recording medium.

### BRIEF DESCRIPTION OF THE DRAWINGS

FIG. 1 is a block diagram showing a configuration of a disc recording/reproducing apparatus 100 according to an example of the invention;

FIG. 2 is a flow chart illustrating an operation of a CPU 30 in a sequential recording;

FIG. 3 illustrates an example of a disc specification view;

FIG. 4 illustrates an example of a preselection view;

FIG. 5 is a flow chart illustrating an operation of the CPU 30 when performing seamless recording;

FIG. 6 is a flow chart illustrating an operation of the CPU 30 when displaying a program;

FIG. 7 illustrates an example of program information;

FIG. 8 illustrates an example of a view displayed when performing recorded program display;

FIG. 9 is a flow chart illustrating an operation of the CPU 30 when playing back a program;

FIG. 10 is a flow chart illustrating an operation of the CPU 30 when performing seamless playback;

FIG. 11 is a flow chart illustrating an operation of the CPU 30 when performing category-based disc specification;

FIG. 12 illustrates an example of a category-based disc specification view;

FIG. 13 is a flow chart illustrating an operation of the CPU 30 when performing category-based timer preselection; and

FIG. 14 illustrates an example of a category-based timer preselection view.

### DETAILED DESCRIPTION OF THE PREFERRED EMBODIMENTS

In the following, embodiments of the invention will be described. A recording apparatus according to an embodiment comprises: a recording device for recording recording data on a recording medium; a changing device for receiving a plurality of recording media supplied from an outside, selecting one of the plurality of recording media as received and replacing a first recording medium loaded in the recording device with a second recording medium as selected; a storage device for storing, during replacement of the first recording medium, the recording data recorded thereon; and a control device for controlling the recording device and the changing device, monitoring a remaining recording capacity or recording time of the first recording medium during recording, causing the first recording medium to be replaced based on monitoring results, and reading, after completion of the replacement of the first recording medium, the recording data of the first recording medium from the storage device and recording same on the second recording medium.

According to the present invention, the recording apparatus can receive a plurality of recording media and record a sequence of recording data dividedly on a plurality of recording media. During a replacement of a recording medium, recording data is stored in a storage device, and once the replacement is completed, the recording data is read from the storage device and recorded on the replacement recording medium. Therefore, the recording data can be recorded without any loss. As a result, the continuous recording time can be increased. The changing device may comprise a receiving section for receiving a plurality of recording media and a transfer mechanism for transferring a recording medium between the recording device and the receiving section, for example. Any recording medium can be used as far as information can be recorded on it. For example, a phase change disc or magneto-optical disc may be used.

There may be preferably adopted a structure in which the recording data includes image data representing a moving picture, and the control device has a detecting device for detecting a correlation between frames in the moving picture, the correlation being lower than a reference value, the control device controlling the changing device to replace the first recording medium when the detecting device detects the correlation, which is lower than the reference value, in case where the remaining recording capacity or recording time of the first recording medium is lower than a reference capacity or reference time. In this case, a scene change is detected based on the correlation of images, and in response to the detection, the recording medium is replaced with a new one.

In broadcasting of a program, while the audio mode is set in the multiplex mode during the program, it is set in the normal mode during commercials. Therefore, a shift to a commercial can be detected by monitoring the audio mode. If the recording data includes image data representing moving pictures and audio data, the control device preferably has a detecting device for detecting a change of the audio mode and causes a replacement of the recording medium if the detecting device detects a change of the audio mode when the remaining recording capacity or recording time of the recording medium is lower than a reference capacity or reference time. In this case, a breakpoint the program is detected based on the change of the audio mode, and in response to the detection, the recording medium is replaced with a new one.

If the recording data includes intra-frame data resulting from coding of the moving picture in a frame and inter-frame data resulting from coding of the moving picture between frames, there may be preferably adopted a structure in which the control device controls the changing device to start replacement of the first recording medium, after completion of recording of the inter-frame data immediately preceding the intra-frame data on the recording medium, and controls the recording device to start recording of data beginning with the intra-frame data onto the second recording medium. For example, the recording data is compression-coded data conforming to the MPEG 2, the recording data comprises an I frame, a P frame and a B frame, and frames beginning with one I frame and ending with the frame immediately preceding the next I frame are managed as a GOP. In this case, recording onto a recording medium is stopped at a boundary between GOPs, and recording onto the next recording medium begins with the next I frame.

In addition, there may be preferably adopted a structure in which the control device reads, for a predetermined period of time from the completion of the replacement of the first recording medium, the recording data from the storage device at a data read rate higher than a data write rate at which the recording data is written to the storage device, and then records the read data onto the second recording medium. In this case, while the amount of data stored in the storage device increases during a replacement of a recording medium, it decreases once the replacement is completed. If both the data read rate and the data write rate are fixed to a certain value, the amount of data stored in the storage device does not decrease even after the replacement, and thus, the storage device has to have a large capacity when the number of replacements of recording media is large. However, according to this embodiment, since the data read rate is set higher for a predetermined period from the end of a replacement of a recording medium, the storage device can have a reduced storage capacity.

There may be preferably adopted a structure in which the storage device has a storage capacity, which is larger than the product of (i) a period of time from a start of the replacement of the first recording medium to a time when recording the data onto the second recording medium becomes possible and (ii) a data write rate at which the recording data is written to the storage device.

There may be preferably adopted a structure in which the recording apparatus further comprises an input device for outputting a signal in accordance with a user's operation, the control device generating, based on the signal output from the input device, set-specification information for specifying recording media which constitute a set of recording media in the plurality of recording media as received, controlling the recording device and the changing device based on the set-specification information to record a part of the recording data on one of the set of recording media, and then continuously recording another part of the recording data, which follows the part of the recording data, on another recording medium of the set of recording media. In this case, the user can select desired recording media from the plurality of received recording media for forming a set, and record data sequentially on the selected recording media.

Furthermore, there may be preferably adopted a structure in which the set-specification information includes information for specifying an order of recording media in which the recording data are to be recorded, and the control device controls the recording device and the changing device so as to record the recording data on respective recording media of the set of recording media sequentially in the order specified by the set-specification information. In this case, the order of recording can be specified. If the recording data is images of programs, the order of recording may be specified on a program basis.

There may be preferably adopted a structure in which the control device controls the recording device and the changing device to record the set-specification information on the recording media of the set of recording media. In this case, when a recorded medium of the set of recording media, having been removed out of the recording apparatus, is received in the recording apparatus again, whether the recording medium is a member of the set can be determined by reproducing the set-specification information. Thus, the recording data can be recorded sequentially on the set of recording media.

In addition, there may be preferably adopted a structure in which the recording apparatus further comprises: a reading device for reading the set-specification information from the plurality of recording media as received; and a device for generating output image data that provides a view for displaying a state of sets of the recording media as received, based on the set-specification information as read, and prompting the user to specify a new set of recording media. In this case, the user can specify the new set while knowing the existing set(s).

If the recording apparatus described above has an input device that outputs a signal in accordance with a manipulation by a user and is capable of recording recording data dividedly on recording media having previously recorded thereon set-specification information which specifies a set of recording media to be subjected to the sequential recording, the recording apparatus can be controlled in a control method described below. The control method comprises: a step of reading the set-specification information from a plurality of recording media supplied from an outside; a step of displaying an image for prompting specification of the set of recording media to be subjected to the sequential recording, based on the set-specification information as read; and
a step of recording, after the set of recording media to be subjected to the sequential recording is specified by the input device, recording a part of the recording data on one of the set of recording media, and then continuously recording another part of the recording data, which follows said part of the recording data, on another recording medium of the set of recording media. According to this control method, the recording data can be recorded sequentially on the recording media which are designated as a set.

A recording apparatus according to another embodiment records one or more pieces of recording data on one recording medium selected among from a plurality of recording media supplied from an outside, and enables, when the recording medium has no available recording space, an update recording to be performed to conduct overwriting with new recording data in a recording area in which the recording data have currently been recorded. The recording apparatus comprises: a recording device for recording the recording data on a recording medium; a changing device for receiving a plurality of recording media supplied from an outside, selecting one of the plurality of recording media as received and replacing a first recording medium loaded in the recording device with a second recording medium as selected; an input device for outputting a signal in accordance with a user's operation; and a control device for generating, based on the signal output from the input device, update recording information for specifying a recording medium, which allows update recording, in the plurality of recording media as received, determining, based on the update recording information, whether the recording medium being currently recorded is allowed to be subjected to the update recording, and controlling, when allowed, the recording device to perform the update recording on the recording medium.

This recording apparatus can specify a recording medium which allows update recording in the plurality of recording media received therein and conduct the update recording on the specified recording medium.

There may be preferably adopted a structure in which the control device controls the recording device and the changing device to record the update recording information on the recording medium, which is allowed to be subjected to the update recording. In this case, when a recorded medium having been removed out of the recording apparatus is received in the recording apparatus again, whether the recording medium allows update recording can be determined by reproducing the update recording information. Thus, the update recording can be conducted following the specification previously made.

There may be preferably adopted a structure in which the recording apparatus further comprises: a reading device for reading the update recording information from the plurality of recording media as received; and a device for generating output image data that provides a view for displaying a state of allowance of update recording for the plurality of recording media as received, based on the update recording information as read, and prompting the user to specify the update recording. In this case, the user can newly specify the update recording while knowing a state of allowance of update recording.

The control device described above may generate, based on the signal output from the input device, set-specification information for specifying recording media which constitute a set of recording media in the plurality of received recording media, generate update recording information for specifying a recording medium which allows update recording, in the plurality of recording media as received, control the recording device and the changing device based on the set-specification information to record a part of the recording data on one of the set of recording media, and then continuously record another part of the recording data, which follows said part of the recording data, on another recording medium of the set of recording media, control, when all of the set of recording media have no available recording space, the recording device and the changing device based on the update recording information to specify a recording medium, which allows update recording, in said set of recording media, and conduct overwriting with new recording data in a recording area of said recording medium as specified, in which the recording data have currently been recorded. In this case, both of set-specification and update recording specification can be made for a recording medium.

If the recording apparatus described above has an input device that outputs a signal in accordance with a manipulation by a user and is capable of recording recording data on a recording medium having previously recorded thereon update recording information which allows update recording in which a recording area in which the recording data is first recorded is overwritten with new recording data when there is no available recording space in the recording medium, this recording device can be controlled in a control method described below. That is, the method comprises: a step of reading the update recording information from a plurality of recording media supplied from an outside; a step of displaying an image that indicates recording media of the plurality of recording media as received, which allow the update recording to be performed and prompts specification of a recording medium to be subjected to recording, based on the update recording information as read; and a step of overwriting, after the recording medium to be subjected to the recording is specified by the input device, a recording area in which the recording data has first been recorded, with new recording data when the recording medium has no available recording space, in case where the recording medium as specified allows update recording. According to this control method, the user can specify an update recording while knowing the recording medium (media) which allows update recording.

The recording apparatus according to another embodiment comprises: a recording device for recording recording data on a recording medium; a changing device for receiving a plurality of recording media supplied from an outside, selecting one of the plurality of recording media as received and replacing a first recording medium loaded in the recording device with a second recording medium as selected; an input device for outputting a signal in accordance with a user's operation; and a control device for generating, based on the signal output from the input device, category information that indicates a category of the recording data to be recorded on each of the recording media as received and controlling the recording device to record the category information on the recording media. This recording apparatus can manage the received recording media according to the categories thereof. As a result, the recording media can be managed according to their genres, such as news and movie, or on a user basis, for example.

There may be adopted preferably a structure in which the recording apparatus further comprises: a reading device for reading the category information from the plurality of recording media as received; and a device for generating output image data that provides a view for displaying a category for each recording medium based on the category information as read and prompting a user to select the category of the recording data to be recorded. Furthermore, there may be adopted preferably a structure in which the control device identifies the category as selected, based on the signal output from the input device, and controls the recording device and the changing device to record the recording data on the recording medium with the same category as the category as selected. In this case, the user can record data on a recording medium according to a category only by specifying the category while referencing to the categories previously set.

If the recording apparatus described above has an input device that outputs a signal in accordance with a manipulation by a user and is capable of selectively recording recording data on a recording medium having previously recorded thereon category information which indicates the category of a recorded content, the recording apparatus can be controlled in a control method described below. That is, the control method comprises: a step of reading the category information from a plurality of recording medium supplied from an outside; a step of displaying the category of the recorded content based on the category information as read and prompting specification of a category of recording data to be recorded; and a step of selecting, after the category is specified by the input device, a recording medium with the same category as the specified one and recording the recording data on the recording medium.

A reproducing apparatus according to another embodiment enables sequential reproduction of image data from a plurality of recording media in which a sequence of divided image data and management information which specifies an order of reproduction have been recorded. The reproducing apparatus comprises: a reproducing device for reproducing the image data and the management information from a recording medium of the plurality of recording media; a changing device for receiving the plurality of recording media supplied from an outside, selecting one of the plurality of recording media as received and replacing a first recording medium loaded in the recording device with a second recording medium as selected; an input device for outputting a signal in accordance with a user's operation; and a control device for controlling, when there is made a detection of specification of the sequential reproduction, the changing device and the reproducing device based on the signal output from the input device, to reproduce sequentially the recording media in the reproduction order, which is specified by the management information reproduced from the plurality of recording media as received. This reproducing apparatus can read the management information previously recorded on recording media, identify the order of playback of the recording media and play back the recording media in the identified order of playback. Therefore, the user can enjoy sequential playback without changing the recording media. In addition, there is no need of specifying the order of playback when playing back the recording media.

There may be preferably adopted a structure in which the above mentioned reproducing apparatus further comprises a storage device for storing the image data output from the reproducing device and outputting the image data as stored, on a FIFO basis, and the control device writes, for a predetermined period of time before completion of replacement of the first recording medium, data on the storage device at a data write rate higher than a data read rate. In this case, since the reproduction data is read from the storage device during replacement of the recording medium, seamless reproduction can be attained.

There may be preferably adopted a structure in which the storage device has a storage capacity, which is larger than the product of (i) a period of time from a start of the replacement of the first recording medium to a time when the reproduction of the data from the second recording medium becomes possible and (ii) a data read rate of the storage device.

### EXAMPLE

Now, the disc recording/reproducing apparatus according to an example of the invention will be described with reference to the accompanying drawings.

<1. Configuration of Disc Recording/Reproducing Apparatus>

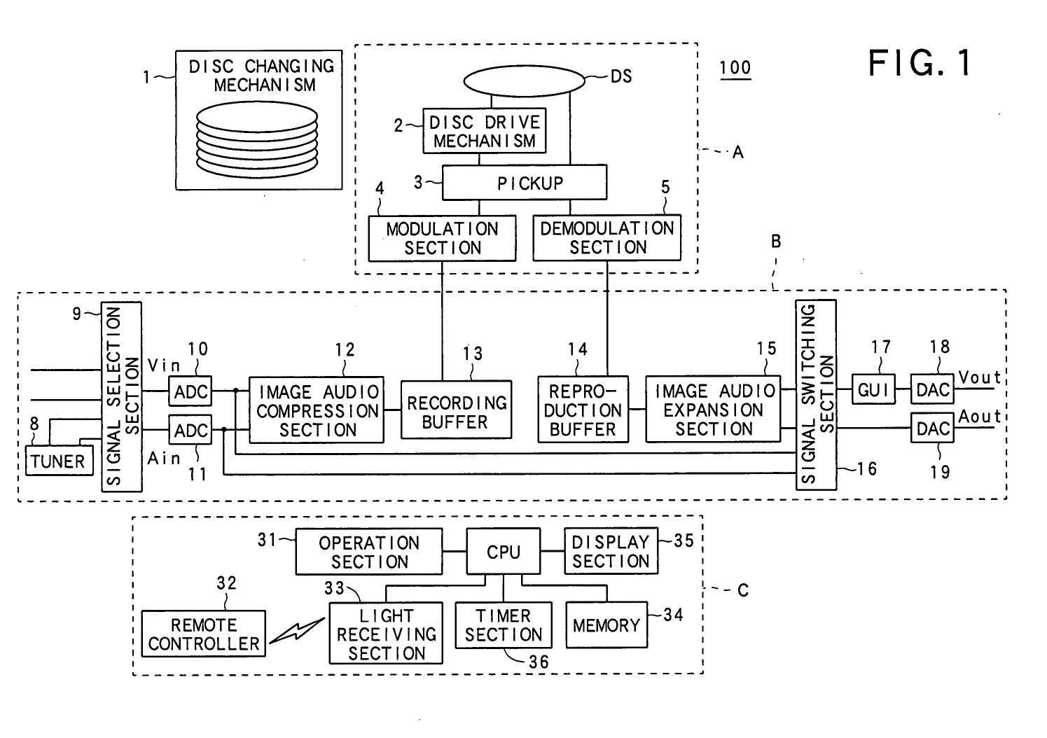

FIG. 1 is a block diagram showing a configuration of a disc recording/reproducing apparatus 100. As shown in this drawing, the disc recording/reproducing apparatus 100 comprises a disc changing mechanism 1, an optical disc drive A, a signal processing unit B, and a control unit C. The disc changing mechanism 1 comprises a receiving section for receiving a plurality of optical discs DS and a transfer mechanism for selecting any one of the optical discs DS received in the receiving section and loading it to the optical disc drive A. The receiving section is constituted by a magazine rack that receives the plurality of optical discs DS stacked vertically or a carousel that receives the same in a planar arrangement.

In a front panel of the apparatus 100, an insertion opening is provided to take in and out an optical disc DS. The user operates a manipulation section 31 or a remote controller 32 to cause a slidable stage to be ejected from the insertion opening. Then, after an optical disc DS is loaded on the stage, the user operates the manipulation section 31 or the remote controller 32 to take the optical disc DS in the apparatus 100. By repeating this procedure, a plurality of optical discs DS are taken in the apparatus and received in the receiving section described above.

The optical disc drive A comprises a disc drive mechanism 2, a pickup 3, a modulation section 4 and a demodulation section 5. The disc drive mechanism 2 further comprises a spindle motor for rotating the optical disc DS and a drive circuit therefor. During recording of data, the pickup 3 irradiates the optical disc DS with light which is modulated in accordance with data to be recorded, thereby writing the data to the optical disc DS. During reproduction of data, the pickup 3 irradiates the optical disc DS with light, receives the reflected light, converts the same into an electrical signal and outputs the signal. The modulation section 4 modulates recording data read from a recording buffer 13 described later, and the demodulation section 5 demodulates the output signal of the pickup 3 to provide reproduction data.

The signal processing unit B generates the recording data based on an input image signal Vin and an input audio signal Ain and generates an output image signal Vout and an output audio signal Aout based on the reproduction data. A signal selection section 9 chooses a set of an image signal and an audio signal supplied from an outside thereto and a set of an image signal and an audio signal supplied thereto from a tuner 8, and outputs them as the input image signal Vin and the input audio signal Ain. The tuner 8 selects a broadcast channel and outputs the image signal and the audio signal based on an instruction from the CPU 30. AD converters (ADCs) 10 and 11 convert the analog input image signal Vin and the analog input audio signal Ain into digital ones and supply the digital signals as input image data and input audio data to an image audio compression section 12. The image audio compression section 12 performs compression coding on the input image data and the input audio data to provide the recording data.

Compression coding used in this example is differential DCT coding conforming to the MPEG (Moving Picture Expert Group) standard. In this case, the recording data, which is temporally compressed, comprises an I frame (intra-frame coded image), a P frame (inter-frame forward prediction coded image) and a B frame (inter-frame bidirectional prediction coded image). That is, in the I frame, intra-frame data is generated as a result of coding in the frame, and in the P and B frames, inter-frame data are generated as a result of coding between the frames. Images beginning with one I frame and ending with the frame immediately preceding the next I frame are managed in the unit called GOP (Group Of Picture).

The recording-data is temporarily stored in the recording buffer 13, and then read therefrom to be supplied to the optical disc drive A. The data write rate at which the recording data is written to the recording buffer 13, which depends on which mode is designated, the standard mode or the long play mode, is adjusted to a target data rate by controlling the image audio compression section 12. On the other hand, the data read rate at which the recording data is read from the recording buffer 3 is controlled by the CPU 30 in the control unit C described later. The recording buffer 13 is constituted by a RAM. Given that the recording buffer 13 has a memory capacity of M and a data write rate (program data rate) of A, the time required for replacement of a disc is TC, and the seek time is S, the memory capacity M can be expressed as a formula: M>A×(TC+S). In this formula, the term (TC+S) denotes the time from a point at which replacement of an optical disc DS with a new one is started to a point at which the new optical disc DS becomes available for recording.

On the other hand, the reproduction data supplied from the optical disc drive A is temporarily stored in a reproduction buffer 14. The data read rate at which the reproduction data is read from the reproduction buffer 14 is constant, while the data write rate of the reproduction buffer 14 is control by the CPU 30. When the reproduction data is read out, an image audio expansion section 15 expands the reproduction data to provide reproduction image data and reproduction audio data. The reproduction buffer 14 is constituted by a RAM. Given that the reproduction buffer 14 has a memory capacity of M and a data read rate (program data rate) of A, the time required for replacement of a disc is TC, and the seek time is S, the memory capacity M can be expressed as a formula: M>A×(TC+S). In this formula, the term (TC+S) denotes the time from a point at which replacement of an optical disc DS with a new one is started to a point at which the new optical disc DS becomes available for recording.

A signal switching section 16 selects any one of the set of the input image data and the input audio data and the set of the reproduction image data and the reproduction audio data based on an instruction from the CPU 30 and outputs the selected set as the output image data and the output audio data. A GUI 17 synthesizes the output image data with predetermined image data. The predetermined image data is an image representing an icon or text, for example. This enables various kinds of user interfaces to be provided. A DA converter (DAC) 18 converts the output data of the GUI 17, which is a digital signal, into an analog signal to provide the output image signal Vout. A DA converter (DAC) 19 generates the output audio signal Aout from the output data of the signal switching section 16.

The control unit C comprises the CPU 30, the manipulation section 31, the remote controller 32, a light receiving section 33, a memory 34, a display section 35 and a timer section 36. The CPU 30 acts as a control center that controls components of the disc recording/reproducing apparatus 100 in accordance with a control program. The manipulation section 31 is provided on the front panel of the apparatus 100 and allows the user input an operation instruction. The remote controller 32 is a device for the user to input an operation instruction and emits infrared rays associated with the manipulation by the user. The light receiving section 33 receives the infrared rays from the remote controller 32 and outputs a signal to the CPU 30. The display section 35 is provided on the front panel of the apparatus 100 and indicates various kinds of information, such as recording time and reproduction time. The memory 34 serves as a work area for the CPU 30 and stores various kinds of information. The timer section 36 counts clock signals to generate date and hour information indicating current date and hour. The disc recording/reproducing apparatus 100 is provided with a timer preselection function. The user can manipulate the manipulation section 31 or remote controller 32 to previously designate a channel for a program to be recorded, a start time of recording, an end time of recording or the like. These pieces of information are stored in the memory 34 as timer recording information. The CPU 30 constantly compares the start time of recording indicated by the timer recording information with the current time indicated by the date and hour information, and if the two times coincide with each other, controls the entire apparatus 100 to make it start recording onto a predetermined optical disc DS.

With such a configuration, the disc recording/reproducing apparatus 100 can take a plurality of optical discs DS in the main unit and perform recording/reproduction of data to/from the optical discs DS.

In the recording operation, the disc recording/reproducing apparatus 100 may be in a sequential recording state in which one program is recorded separately onto a plurality of optical discs DS or an independent recording state in which one program is recorded onto one optical disc DS without disc change. Furthermore, in the recording operation, the disc recording/reproducing apparatus 100 may be in an update recording state in which the records can be successively overwritten in the order of their recording or a single recording state in which recording onto a disc is stopped when the disc has no available recording space.

For each optical disc DS, the user can specify which to use, the sequential recording or independent recording or the update recording or single recording, by manipulating the manipulation section 31 or the remote controller 32. If no specification is made, the optical discs DS are managed based on the hypothesis that the independent recording and the single recording are designated.

In the sequential recording, recording has to be continued by changing from one optical disc DS to another during the recording. Thus, among a plurality of optical discs DS received in the main unit, discs to be subjected to the sequential recording can be specified. In the following description, a plurality of optical discs DS to be subjected to the sequential recording is referred to as a “disc set”, and specification of a disc set is referred to as “set-specification”. If four or more optical discs DS can be received, a pair of optical discs DS can be regarded as one disc set, and a plurality of set-specifications can be made. In set-specification, set-specification information is generated which identifies the optical discs DS constituting the disc set and specifies the order of recording. Furthermore, if an optical disc that allows update recording is specified, update recording information is generated.

The set-specification information and the update recording information are recorded to each optical disc DS as a part of disc management information and stored in the memory 34. The disc management information is used to manage recording and reproduction to and from the optical disc DS and includes, besides the set-specification information and the update recording information, program information, recording enable/disable information and free space information. The program information concerns the recorded program and includes the title, recording date and hour or the like. The recording enable/disable information indicates whether the optical disc DS is a playback-only one or writable one. The free space information indicates the volume of data the optical disc DS can further record.

<2. Operation Of Disc Recording/Reproducing Apparatus>

Now, an operation of the disc recording/reproducing apparatus 100 will be described.

<2-1: Sequential Recording>

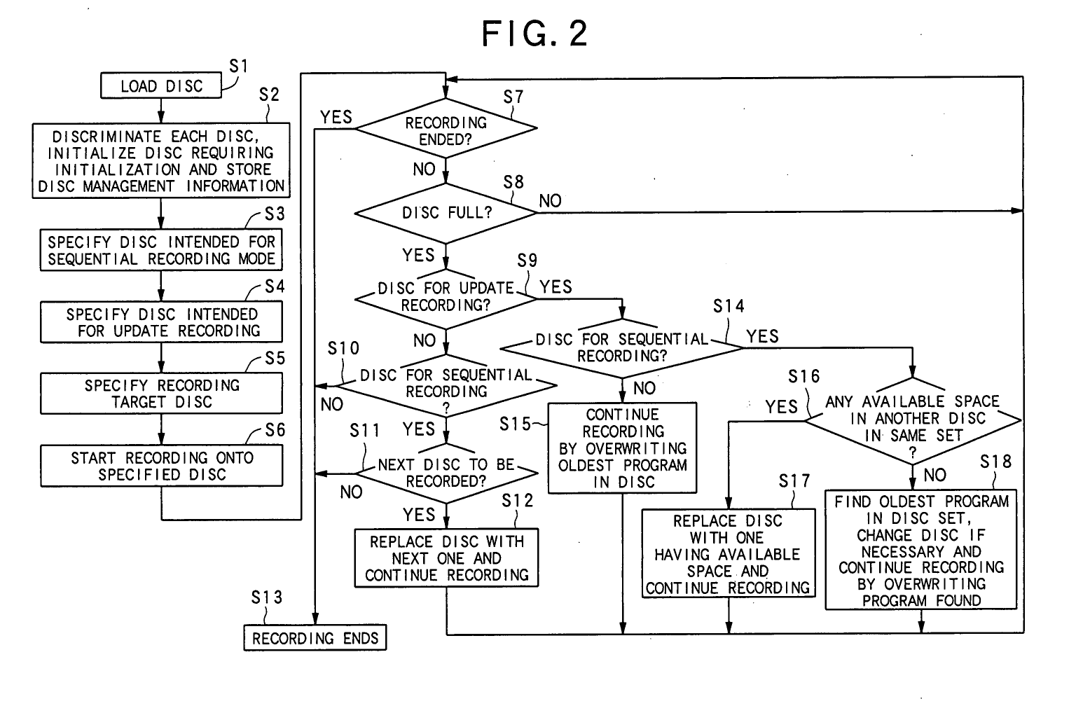

First, sequential recording in which sequential moving pictures are recorded onto a plurality of optical discs DS will be described. FIG. 2 is a flow chart illustrating an operation of the CPU 30 in the sequential recording. In the sequential recording, first, a plurality of optical discs DS are taken in the main unit of the apparatus 100 (step S1). The plurality of optical discs DS taken in the main unit are received in the receiving section of the disc changing mechanism 1. Then, the CPU 30 transfers the received optical discs DS to the optical disc drive A, determines whether the optical discs are playback-only ones or writable ones, and if any disc requires initialization, initializes the disc(s). Furthermore, the CPU 30 plays back each optical disc DS, reads the recorded disc management information therefrom and stores the disc management information in the memory 34 (step S2).

Then, in response to the user manipulating the manipulation section 31 or remote controller 32 to specify the sequential recording mode, the CPU 30 performs set-specification for the optical discs DS (step S3), and then, specifies the optical discs DS for which the update recording is to be performed (step S4).

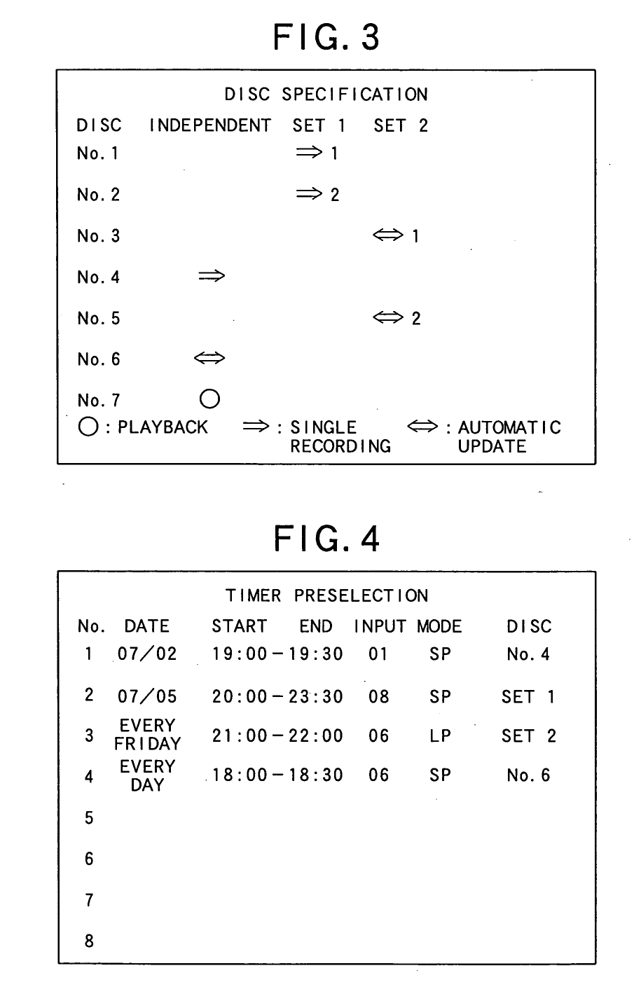

In these specification processings, the CPU 30 controls the GUI 117 to cause it to display a disc specification view on a monitor or the display section 35. FIG. 3 shows an example of the disc specification view. In this example, seven optical discs DS are received. In this disc specification view, the numbers “No. 1” to “No. 7” indicate the numbers of optical disc, respectively, “independent” means that the disc is not specified in set-specification, and “set 1” and “set 2” indicate the optical discs specified in set-specification.

In this example, the optical discs DS assigned the disk numbers of 4, 6 and 7 are each managed as one independent optical disc DS. Of these, the optical discs DS having the numbers of 4 and 6 are writable discs. On the other hand, the optical disc DS having the disc number of 7 is a playback-only disc, and is protected from being written. The optical disc DS having the disc number of 4 allows only single recording and is protected from being overwritten. The optical disc having the disc number of 6 has recorded data overwritten (automatically updated) in the order of recording if the recording space is filled with data.

The optical discs DS having the disc number of 1 and 2 are managed as a set 1 and the optical discs DS having the disc number of 3 and 4 are managed as a set 2. For the set 1, sequential recordings onto the disc 1 and the disc 2 are performed in this order. For the set 2, sequential recordings onto the disc 3 and the disc 5 are performed in this order. If the whole recording space is filled with data, the recorded data are overwritten in the order of their recording.

The user can manipulate the manipulation section 31 or remote controller 32 to specify or change the set of optical discs DS or specify or change the optical discs DS for which update recording is performed. Based on a signal output from the manipulation section 31 or remote controller 32, the CPU 30 generates set-specification information and update recording information and stores them in the memory 34 as disc management information. Here, the set-specification information includes information that relates the respective optical discs DS to each other in terms of set number (for example, set 1 and set 2) and information that specifies the order of recording.

Referring back to FIG. 2, when the user manipulates the manipulation section 31 or remote controller 32 to specify the optical disc DS or disc set to be subjected to the recording, the CPU 30 detects the specification (step S5), and starts recording onto the specified optical disc DS or disc set (step S6). In step S5, when specifying timer preselection, besides the start date and hour, the end date and hour, the channel and the recording mode, the disc number or disc set is also specified. In step S6, when a recording key is manipulated or the start date and hour set in the timer is reached, the specified optical disc DS is selected and recording is started.

FIG. 4 shows an example of a preselection view used in timer preselection. The CPU 30 controls the GUI 17 based on timer preselection information to cause it display the preselection view on the monitor. In this example, preselection items No. 1 to No. 4 are displayed. In the preselection item 1, it is specified that the program broadcasted on the channel 1 between 7 p.m. and 7:30 p.m. on July 2 is recorded in the normal mode to the optical disc DS having the disc number of 4. In the preselection item 3, it is specified that the program broadcasted on the channel 6 between 9 p.m. and 10 p.m. every Friday is recorded in the long play mode to the optical discs DS in the set 2.

Then, the CPU 30 determines whether to stop recording or not (step S7). Specifically, it is determined whether a recording stop button is pressed or whether the end time set in the timer is reached. If the recording is determined to be stopped, the process continues to step S13, and the process is ended.

On the other hand, if the recording is determined not to be stopped, the CPU 30 continues the process to step S8. The CPU 30 determines whether the recording space of the optical disc DS to which data is currently recorded is filled with data (step S8), and if there is any available recording space, the process returns to step S7 and the steps S7 and S8 are repeated. Then, when there is no available recording space, the CPU 30 continues the process to step S9, and based on the disc management information, determines whether the update recording is specified for the relevant optical disc DS (step S9).

If the update recording is not specified, the CPU 30 determines whether the sequential recording is specified for the optical disc DS (whether set-specification is made for the optical disc) based on the disc management information (step S10). If the sequential recording is not specified, there is no disc for which recording is to be performed next. Thus, the CPU 30 continues the process to step S13, and the recording is ended. On the other hand, if the sequential recording is specified, the CPU 30 continues the process to step S11 and determines whether the main unit of the apparatus 100 receives any optical disc for which recording is to be performed next. If there is no optical disc DS for which recording is to be performed next, the CPU 30 continues the process to step S13, and the recording is ended. On the other hand, if there is any optical disc DS for which recording is to be performed next, the disc filled with data is replaced with the new disc DS, and the recording is continued (step S12). Here, a processing during changing of the optical disc DS will be described in detail in connection with a seamless recording processing described later.

Then, if the determination result in step S9 is “YES”, that is, if the update recording is specified for the optical disc DS for which recording being performed, the CPU 30 continues the process to step S14, and determines whether the sequential recording is specified for the optical disc DS (whether set-specification is made for the optical disc) based on the disc management information. If the sequential recording is not specified, the CPU 30 identifies the program having the oldest recording time in the programs recorded on the current optical disc DS based on the disc management information stored in the memory 34 and continues recording by overwriting the recording space in which the identified program is recorded.

If the sequential recording is specified, the CPU 30 determines whether one or more optical discs DS in the set other than the current one have an available recording space based on the disc management information stored in the memory 34 (step S16). If one or more discs have an available recording space, the CPU 30 selects one for which the latest recording is performed among from the optical discs DS in the set, replaces the current disc with the selected optical disc DS and continues recording using the available recording space (step S17).

On the other hand, if the determination result in step S16 is “NO”, that is, if there is no optical disc DS in the set which has an available space, the CPU 30 continues the process to step S18 and performs the procedure described below. In the first place, the CPU 30 identifies the program having the oldest recording time in the optical discs DS in the set based on the disc management information stored in the memory 34. In the second place, the CPU 30 determines whether the identified program is recorded on the optical disc DS for which recording is being performed. In the third place, if it is determined that the identified program is recorded on another optical disc DS, the CPU 30 replaces the current disc with the disc having the identified program recorded. In the fourth place, the CPU 30 overwrites the recording space of the disc in which the identified program is recorded.

In the sequential recording described above, as for the disc management information, the CPU 30 performs the procedure described below. First when the optical disc DS being used for recording of the program is filled with data and the disc DS is replaced with a new optical disc DS, secondly when overwriting of the recorded program with a new program is performed, and thirdly when the recording is completed, the CPU 30 updates the disc management information stored in the memory 34 in accordance with the respective operations. Furthermore, when the recording is completed, the disc management information stored in the memory 34 is written to all the optical discs DS used for recording, thereby updating the disc management information in the optical discs DS.

As described above, in the case where the sequential recording is simply specified, the disc recording/reproducing apparatus 100 successively performs recordings onto the specified optical discs DS until all the optical discs DS in the set are filled with data, and in the case where the update recording onto a single optical disc DS is specified, the apparatus overwrites the program having the oldest recording time when the optical disc DS is filled with data. Furthermore, in the case where the update recording is specified for a disc set, when one optical disc DS is filled with data, if any other disc in the set has an available recording space, the space is used for recording, or if no other disc in the set has an available recording space, the program having the oldest recording time in the disc set is overwritten.

<2-2: Seamless Recording>

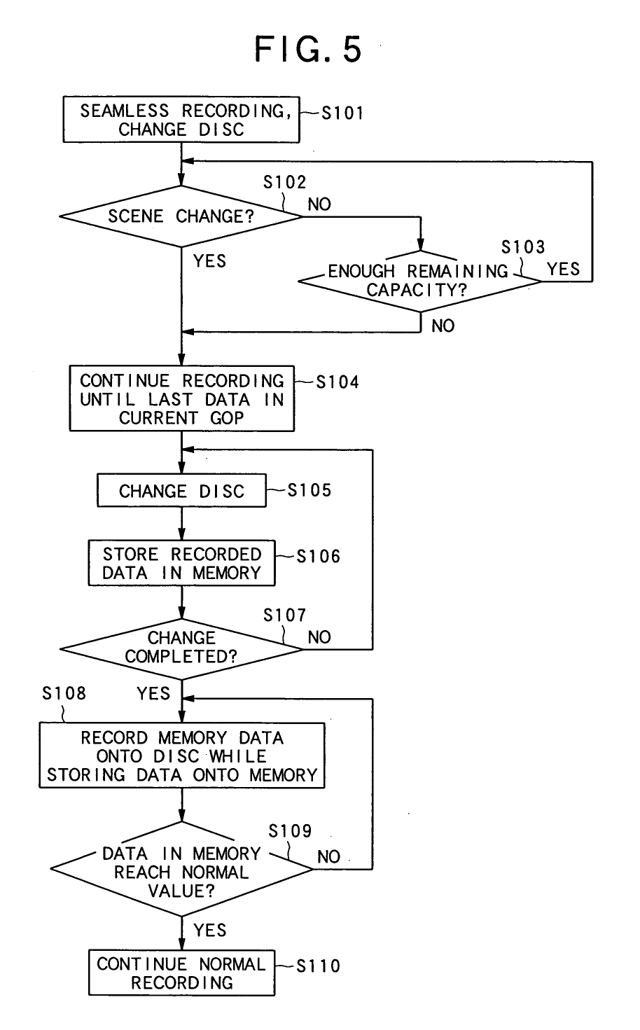

Now, seamless recording will be described. The seamless recording is a processing performed during changing of the optical disc DS in the sequential recording described above, and is performed in steps S12, S17 and S18 shown in FIG. 2. FIG. 5 is a flow chart illustrating an operation of the CPU 30 in the seamless recording.

First, while performing the sequential recording, the CPU 30 issues a disc change request when the remaining capacity of the current optical disc DS becomes lower than a predetermined value (step S101). When the disc change request is issued, the current optical disc DS is not replaced with a new one immediately after that, but the CPU 30 determines whether there is a scene change or not (step S102). For example, in this determination step, the absolute value of a variation between the current frame and the preceding frame is calculated for each pixel, the absolute values are added, and if the sum is higher than a predetermined value, it is determined that there is a scene change.

If there is no scene change, the CPU 30 determines whether the remaining capacity is tight (step S103). Specifically, the CPU 30 determines whether or not the remaining capacity is equal to or higher than a predetermined value, and if it is equal to or higher than the predetermined value, returns the process to step S102. If the remaining capacity is lower than the predetermined value, or if there is a scene change, the CPU 30 continues recording of data until the current GOP is ended. Although the determination in step S103 is performed in terms of remaining capacity, the determination-may be performed whether or not the remaining recording time is equal to or longer than a predetermined time.

Then, the CPU 30 controls the disc changing mechanism 1 to cause it to replace the current optical disc DS (i.e., the first recording medium) with the optical disc DS (i.e., the second recording medium) for which recording is to be performed next (step S105). Then, the CPU 30 stores data to be recorded occurring during the change of the optical disc in the recording buffer 13 (memory) (step S106), and determines whether the change of the optical disc is completed (step S107). If it is determined that the change is not completed, the CPU 30 returns the process to step S105 and repeats steps S105 to S107.

When the change is completed, the CPU 30 transfers the recorded data stored in the recording buffer 13 (which is stored in step S106) to the optical disc drive A, while continuously storing data into the recording buffer 13 (step S108). Thus, the data which would otherwise have been recorded during the change of the optical disc DS can be recorded to the new optical disc DS without any loss. In this procedure, the CPU 30 keeps the data read rate at which data is read from the recording buffer 13 higher than the data write rate at which data is written to the recording buffer 3 and controls the disc drive mechanism 2 in accordance with the data read rate so that a pit length for each bit recorded to the optical disc DS is constant. Accordingly, the amount of data in the recording buffer 13 is gradually reduced.

Then, the CPU 30 determines whether the amount of data in the recording buffer 13 reaches a normal value (step S109). If the data amount is higher than the normal value, the CPU 30 returns the process to step S108 and repeats steps S108 and S109. When the data amount reaches the normal value, the CPU 30 turns the recording state into the normal recording state.

As described above, during the change of the optical disc DS, data is stored in the recording buffer 13, and after the change is completed, the recorded data is read from the recording buffer 13 and recorded again on the new optical disc DS. Therefore, the data can be recorded on the optical discs DS without any loss.

Keeping the data read rate of the recording buffer 13 higher than the data write rate thereof is to reduce the storage capacity of the recording buffer 13. Specifically, if the optical discs DS are changed more frequently, the amount of data to be recorded during the changes increases. If the data read rate of the recording buffer 13 equals to the data write rate thereof, the storage capacity of the recording buffer 13 has to be increased in response to the increase of the number of times of the changes. However, if the data read rate is higher than the data write rate, the amount of data recorded on the recording buffer 13 is reduced, and thus, the storage capacity of the recording buffer 13 can also be reduced.

<2-3: Display of Recorded Program>

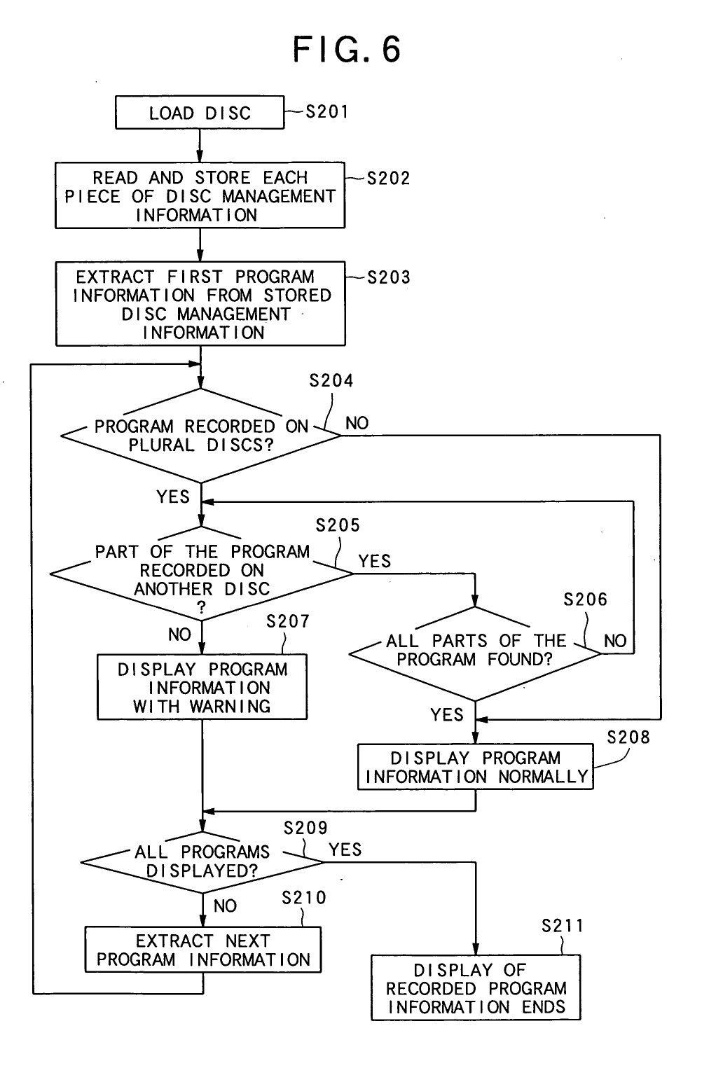

Now, a processing of displaying a recorded program will be described. FIG. 6 is a flow chart illustrating an operation of the CPU 30 when displaying a program recorded on an optical disc DS. First, a plurality of optical discs DS are taken in the main unit of the apparatus 100 (step S201). The plurality of optical discs DS taken in the main unit are received in the receiving section of the disc changing mechanism 1. Then, the CPU 30 transfers the received optical discs DS to the optical disc drive A, plays back the optical discs DS, reads the recorded disc management information therefrom and stores the disc management information in the memory 34 (step S202).

Then, the CPU 30 identifies a first piece of program information based on the stored disc management information (step S203), and determines whether the identified program is the one sequentially recorded on a plurality of optical discs DS (step S204). Specifically, if set-specification is made for an optical disc DS having the identified program recorded thereon, the CPU 30 determines that the program is recorded in the sequential recording mode, and if set-specification is not made therefor, the CPU 30 determines that the program is not recorded in the sequential recording mode.

In the case where the program is recorded in the sequential recording mode, the CPU 30 determines whether any other optical disc(s) DS received in the apparatus has a part of the program recorded thereon based on the disc management information stored in the memory 34 (step S205). If any other optical disc(s) has a part of the program, the CPU continues the process to step S206, in which it is determined whether all the parts of the program are found. If all the parts of the program are not found, the process returns to step S205, the disc management information of another optical disc is further searched.

If all the parts of the program are found, or if the program is not recorded in the sequential recording mode, the CPU 30 displays the program information normally (step S208). On the other hand, if search for another optical disc having a part of the program in step S205 is failed, the CPU 30 displays the program information with a warning (step S207).

Then, the CPU 30 determines whether all the programs have been displayed (step S209). If not, the CPU 30 identifies a next program (step S210) and returns the process to step S204. If all the programs have been displayed, display of the recorded program information is finished (step S211). Of course, if the number of programs is too large to display in one view, the programs can be displayed in a plurality of separate views.

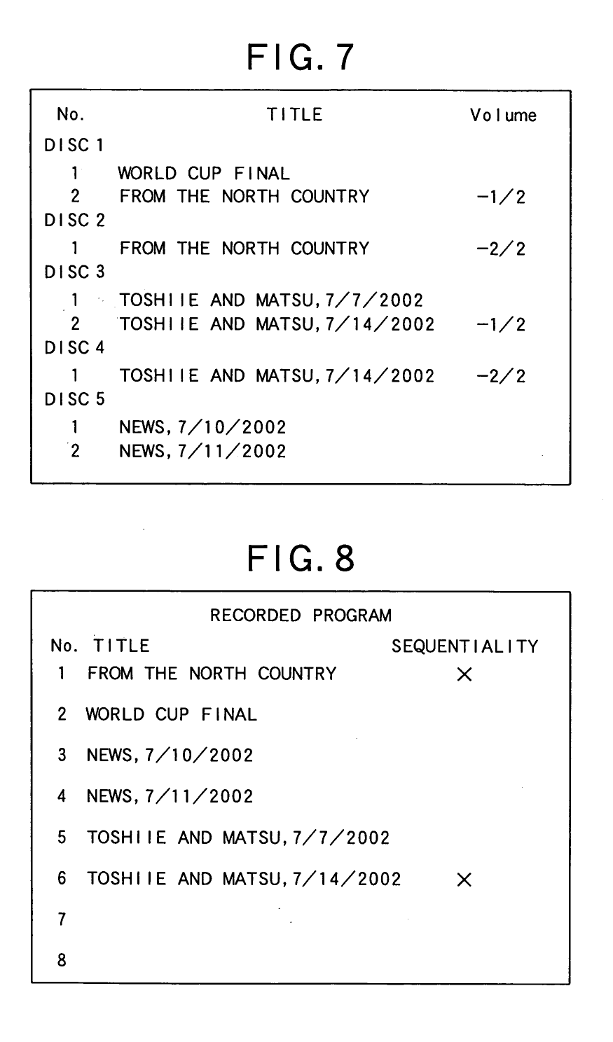

For example, it is assumed that program information shown in FIG. 7 is recorded as the disc management information on five optical discs DS. In the program information in this example, order of programs recorded in the optical discs, the titles of the programs and volume information thereof are associated with each other. The volume information is expressed by B/A, where A denotes the total number of optical discs DS constituting the disc set and B denotes the order of recording. On the optical disc DS having the disc number of 1, “World Cup Final” and “From The North Country” are recorded in this order, and on the optical disc DS having the disc number of 2, the program “From The North Country” is recorded. The optical discs DS having the disc numbers of 1 and 2 constitute one disc set, and the program “From The North Country” is recorded on the disc 1 and the disc 2 in this order. Thus, it is possible to determine the order of the discs having one program recorded thereon, a lack of a disc or the like. The title name may be, by default, the recording date and hour and the channel, or the program title obtained from the EPG or the like. Alternatively, it may be a title entered by the user via a title entry view.

Here, it is assumed that when the optical discs DS having the disc numbers of 1, 3 and 5 is received in the recording/reproducing apparatus 100, the recorded programs are to be displayed. In this case, there is a lack of the optical discs DS having the disc numbers of 2 and 4. FIG. 8 shows an example of a displayed view. As shown in FIG. 7, the optical disc DS having the disc number of 2 has the program “From The North Country” recorded thereon, and the optical disc DS having the disc number of 4 has the program “Toshiie And Matsu, Jul. 14, 2002” recorded thereon. Thus, as for these programs, a warning is displayed in the form of a cross as shown in FIG. 8. This allows the user to know that sequential playback of these programs cannot be attained with the optical discs DS received in the apparatus.

<2-4: Playback of Program>

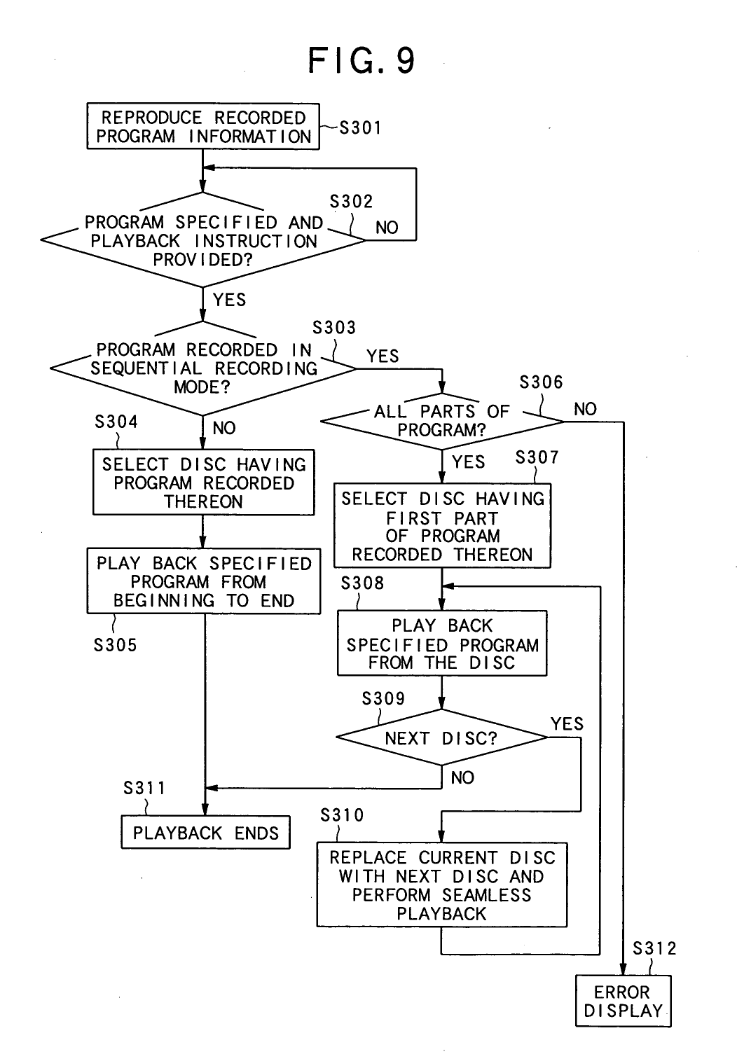

Now, a processing of reproducing a recorded program will be described. FIG. 9 is a flow chart illustrating an operation of the CPU 30 when playing back a program. First, the CPU 30 performs the recorded program display processing described above to display the program information view (step S301). Then, the CPU 30 determines whether a program is specified and a playback manipulation is made (step S302). If it is determined that the playback manipulation is made, the CPU 30 determines whether the selected program is one recorded in the sequential recording mode based on the disc management information (step S303).

If the program is not one recorded in the sequential recording mode, the CPU 30 selects the optical disc DS having the specified program recorded thereon (step S304). Here, if the relevant optical disc DS is received in the receiving section of the disc changing mechanism 1, the CPU 30 controls the disc changing mechanism 1 to cause it to transfer the optical disc DS to the optical disc drive A. Then, the CPU 30 plays back the specified program from the beginning to the end (step S305), and terminates the process (step S311).

On the other hand, if the determination result in step S303 is “NO”, that is, if the selected program is one recorded in the sequential recording mode, the CPU 30 continues the process to step S306, and determines whether all the optical discs DS having the program recorded thereon are found based on the disc management information (step S 306). If not, the CPU 30 performs error display and terminates the process (step S312).

If all the optical discs DS are found, the determination in step S306 results in “YES”. Then, the CPU 30 selects the optical disc DS having the first part of the program recorded thereon based on the disc management information (step S307), and plays back the specified program from the optical disc from the beginning thereof (step S308).

Then, when the specified program being played back from the optical disc DS approaches the end thereof, the CPU 30 determines whether there is a next optical disc DS (step S309). If there is a next optical disc DS, the current optical disc is replaced with the next optical disc DS and the disc is played back seamlessly (step S310). Seamless playback will be described later. If there is no next optical disc, this means that all the optical disc DS in the set is completely played back. Therefore, the CPU 30 continues the process to step S311 and terminates the playback.

In this example, when a program is recorded in the sequential recording mode, the process is stopped by error display (steps S306 and S312) if all the parts of the program are found. However, the program may be played back from the received optical discs DS.

<2-5: Seamless Playback>

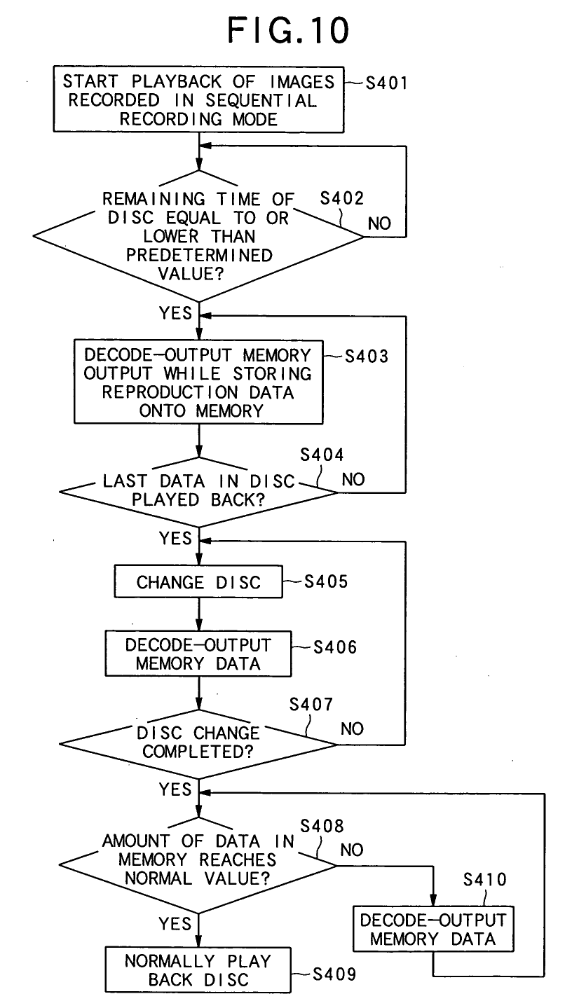

Now, seamless playback in which images are played back continuously during change of an optical disc DS will be described. FIG. 10 is a flow chart illustrating an operation of the CPU 30 when performing seamless playback. When playback of a program recorded in the sequential recording mode is started (step S401), the CPU 30 constantly determines whether or not the remaining playback time of the optical disc DS being played back is equal to or lower than a predetermined value (step S402). If the remaining playback time is equal to or lower than the predetermined value, the CPU 30 continues the process to step S403, in which playback of the program is continued by reading reproduction data to be decoded from the reproduction buffer 14 while storing reproduction data onto the reproduction buffer 14. In this case, the CPU 30 writes the reproduction data onto the reproduction buffer 14 at a data write rate higher than the data read rate of the reproduction buffer 14. The CPU 30 controls the disc drive mechanism 2 in accordance with the data write rate. Thus, the amount of data in the reproduction buffer 14 gradually increases.

Here, the predetermined value T, against which the remaining playback time is compared, is expressed as a formula: T<A×(TC+S)/(P−A), where A denotes a data read rate (program data rate), P denotes a data write rate (reproduction data rate), TC denotes a time required for disc change, and S denotes a seek time.

Then, the CPU 30 determines whether the last data recorded on the optical disc DS being played back is played back (step S404). If the last data is not played back, the CPU 30 returns the process to step S403 and writes the reproduction data onto the reproduction buffer 14.

When the last data on the optical disc is played back, the CPU 30 controls the disc changing mechanism 1 to cause it perform disc change (step S405). During the change of the optical disc DS, the CPU 30 reads the reproduction data to be decoded from the reproduction buffer 14 and continues decoding (step S406). Write of reproduction data onto the reproduction buffer 14 is not performed during the disc change, and therefore, the amount of data in the reproduction buffer 14 gradually decreases. Then, the CPU30 determines whether the change of the optical disc DS is completed (step S407). Steps S405 to S407 are repeated until the disc change is completed.

When the change of the optical disc DS is completed, the CPU 30 determines whether the amount of the reproduction data stored in the reproduction buffer 14 reaches a normal value (step S408). If not, the CPU 30 continues reading the reproduction data to be decoded from the reproduction buffer 14 until the amount of the stored data becomes equal to or lower than the normal value (step S410). If it is equal to or lower than the normal value, the process enters normal playback of the optical disc DS (step S409), in which the optical disc is played back with the amount of data stored in the reproduction buffer being kept at a normal level while the reproduction data is being written to the reproduction buffer 14.

In step S402, the amount of the remaining reproduction data is determined in terms of remaining playback time. However, of course, it may be determined in terms of remaining capacity.

<2-6: Category-Based Disc Specification>

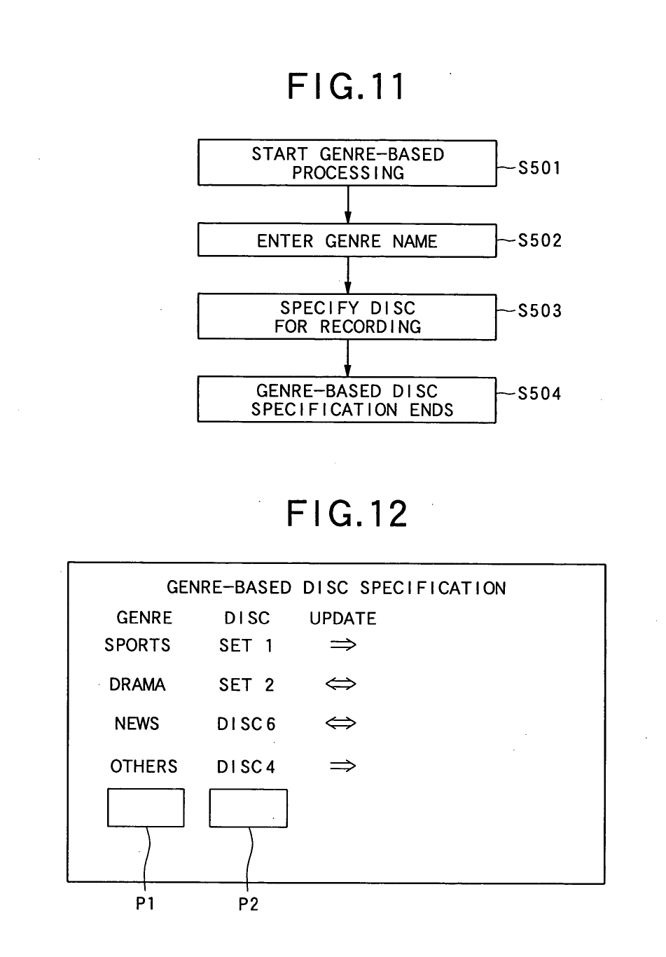

Now, category-based disc specification will be described. FIG. 11 is a flow chart illustrating an operation of the CPU 30 when performing category-based disc specification. It is assumed that set-specification for optical discs DS is previously made. First, when the user manipulates the manipulation section 31 or remote controller 32 to select the category-based disc specification, the CPU 30 detects this and starts category-based disc specification (step S501). In this processing, the CPU 30 controls the GUI 17 based on the disc management information to cause it to display a category-based disc specification view. The disc management information includes a disc ID, recording enable/disable information and free space information.

FIG. 12 shows an example of the category-based disc specification view. In this example, categories include “sports”, “drama”, “news” and “others”. Of these, disc set-specification is made for the categories “sports” and “drama”, and no disc set-specification is made for the categories “news” and “others”.

Then, when the user enters a desired category name in a category entry field P1 in the category-based disc specification view (step S502) and enters a disc number or disc set-specification which is to be used for recording in a disc entry field P2 (step S503), the CPU 30 stores the category name and the disc number or disc set-specification in the memory 34 as category information by associating the entries with each other. The CPU 30 manages the category information as a part of the disc management information and records it onto each optical disc DS.

A plurality of categories may be allocated to a same optical disc DS or optical disc set. If a user name is entered rather than a category name, user-based management is also possible.

<2-7: Category-Based Timer Preselection>

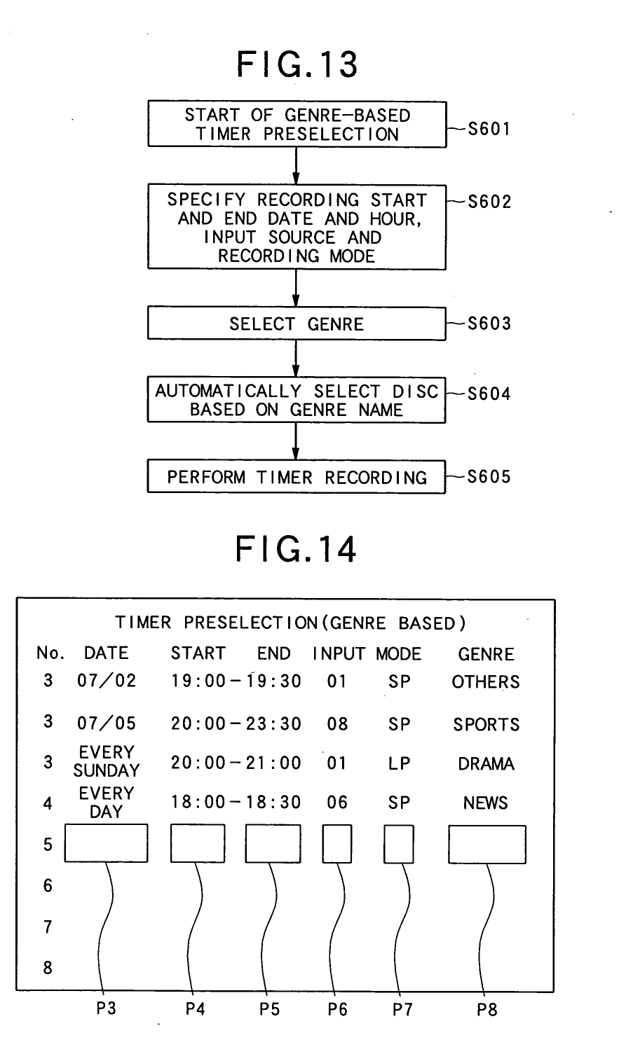

Now, category-based timer preselection will be described. FIG. 13 is a flow chart illustrating an operation of the CPU 30 when performing category-based timer preselection. Here, it is assumed that the category-based disc specification is previously made. First, when the user manipulates the manipulation section 31 or remote controller 32 to select the category-based timer preselection, the CPU 30 detects this and starts category-based timer preselection (step S601). In this processing, the CPU 30 controls the GUI 17 based on the disc management information to cause it to display a category based timer preselection view. FIG. 14 shows an example of the category-based timer preselection view. In this example, there are displayed the recording date, the recording start time, the recording end time, the input source, the recording mode and the category. For example, a preselection 4 specifies that a program on the channel 6 is recorded every day between 6 p.m. and 6:30 p.m. in the normal mode onto an optical disc DS for which the category information is designated as “news”.

Then, the user enters a recording date, a recording start time, a recording end time, an input source and a recording mode in entry fields P3 to P7 in the category-based timer preselection view respectively (step S602). When a category is entered in a category entry field P8 (step S603), the CPU 30 stores the category name and the information concerning recording in the memory 34 as category-based preselection information by associating them with each other. That is, in that the user specifies a category, the category-based timer preselection is different from a usual timer preselection in which an optical disc DS or disc set to be subjected to the recording is specified.

Then, the CPU 30 identifies the category name based on the category-based preselection information and automatically selects an optical disk DS having the same category name based on the disc management information (step S604). Then, when the time specified by the category-based preselection information comes, the CPU 30 records the program on the selected optical disc DS (step S605).

<3. Modification>

The present invention is not limited to the embodiment and examples described above, and the following modifications can be made, for example.

(1) In the sequential recording described above the order of sequential recording is specified by the user manipulating the manipulation section 31 or remote controller 32. However, the order of sequential recording may be determined based on the positions of the inserted optical discs DS.

(2) In the seamless recording described above, a scene change is detected in step S102 shown in FIG. 5. Instead of this, a change of the audio mode from a multiplex mode to a normal mode may be detected. In general, the audio mode is set in the normal mode during commercials and in the multiplex mode during programs. Therefore, detection of a change of the audio mode allows an optical disc DS change to be started when a commercial is entered. Furthermore, of course, a disc change may be forced by manual operation.

Furthermore, in step S109, it is determined whether the amount of data in the recording buffer 13 reaches a normal value. However, whether the amount of data in the recording buffer 13 has been lower than the normal value or higher than that need not be considered.

(3) In the example described above, the disc management information is recorded on each optical disc DS, and when the optical discs DS are taken in the disc recording/reproducing apparatus 100, the disc management information is read therefrom and stored in the memory 34. However, identification information may be recorded on each optical disc DS and recording of the disc management information may be omitted. In this case, a nonvolatile memory is provided in the disc recording/reproducing apparatus 100, and the identification information and the disc management information can be stored in the nonvolatile memory with being associated with each other.

(4) In the example described above, analog video and audio signals are converted into digital signals and compressed. However, as in digital broadcasting or the like, there may be contemplated a system that receives digital data having already been compressed and records the data therein.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-294307 filed on Oct. 7, 2002 including the specification, claims, drawings and summary is incorporated herein by reference in its entirety.

1. A recording apparatus comprising:
a recording device for recording recording data on a recording medium;
a changing device for receiving a plurality of recording media supplied from an outside, selecting one of the plurality of recording media as received and replacing a first recording medium loaded in the recording device with a second recording medium as selected;
a storage device for storing, during replacement of the first recording medium, the recording data recorded thereon; and
a control device for controlling the recording device and the changing device, monitoring a remaining recording capacity or recording time of the first recording medium during recording, causing the first recording medium to be replaced based on monitoring results, and reading, after completion of the replacement of the first recording medium, the recording data of the first recording medium from the storage device and recording same on the second recording medium.

2. The recording apparatus according to claim 1, wherein;
said recording data includes image data representing a moving picture, and
said control device has a detecting device for detecting a correlation between frames in the moving picture, said correlation being lower than a reference value, said control device controlling the changing device to replace the first recording medium when the detecting device detects the correlation, which is lower than the reference value, in case where the remaining recording capacity or recording time of the first recording medium is lower than a reference capacity or reference time.

3. The recording apparatus according to claim 1, wherein:
said recording data includes intra-frame data resulting from coding of the moving picture in a frame and inter-frame data resulting from coding of the moving picture between frames, and
said control device controls the changing device to start replacement of the first recording medium, after completion of recording of the inter-frame data immediately preceding the intra-frame data on the recording medium, and controls the recording device to start recording of data beginning with the intra-frame data onto the second recording medium.

4. The recording apparatus according to claim 1, wherein;
the control device reads, for a predetermined period of time from the completion of the replacement of the first recording medium, the recording data from the storage device at a data read rate higher than a data write rate at which the recording data is written to the storage device, and then records the read data onto the second recording medium.

5. The recording apparatus according to claim 1, wherein:
said storage device has a storage capacity, which is larger than a product of (i) a period of time from a start of the replacement of the first recording medium to a time when recording the data onto the second recording medium becomes possible and (ii) a data write rate at which the recording data is written to the storage device.

6. The recording apparatus according to claim 1, further comprising:
an input device for outputting a signal in accordance with a user's operation,
said control device generating, based on the signal output from the input device, set-specification information for specifying recording media which constitute a set of recording media in the plurality of recording media as received, controlling the recording device and the changing device based on the set-specification information to record a part of the recording data on one of the set of recording media, and then continuously recording another part of the recording data, which follows said part of the recording data, on another recording medium of the set of recording media.

7. The recording apparatus according to claim 6; wherein:
said set-specification information includes information for specifying an order of recording media in which the recording data are to be recorded, and
said control device controls the recording device and the changing device so as to record the recording data on respective recording media of the set of recording media sequentially in said order specified by the set-specification information.

8. The recording apparatus according to claim 6, wherein:
said control device controls the recording device and the changing device to record the set-specification information on the recording media of the set of recording media.

9. The recording apparatus according to claim 6, further comprising:
a reading device for reading the set-specification information from the plurality of recording media as received; and
a device for generating output image data that provides a view for displaying a state of sets of the recording media as received, based on the set-specification information as read, and prompting the user to specify a new set of recording media.

10. A recording apparatus, which records one or more pieces of recording data on one recording medium selected among from a plurality of recording media supplied from an outside, and enables, when the recording medium has no available recording space, an update recording to be performed to conduct overwriting with new recording data in a recording area in which the recording data have currently been recorded, said recording apparatus comprising:
a recording device for recording the recording data on a recording medium;
a changing device for receiving a plurality of recording media supplied from an outside, selecting one of the plurality of recording media as received and replacing a first recording medium loaded in the recording device with a second recording medium as selected;
an input device for outputting a signal in accordance with a user's operation; and
a control device for generating, based on the signal output from the input device, update recording information for specifying a recording medium, which allows update recording, in the plurality of recording media as received, determining, based on the update recording information, whether the recording medium being currently recorded is allowed to be subjected to the update recording, and controlling, when allowed, the recording device to perform the update recording on the recording medium.

11. The recording apparatus according to claim 10, wherein:
said control device controls the recording device and the changing device to record the update recording information on the recording medium, which is allowed to be subjected to the update recording.

12. The recording apparatus according to claim 11, further comprising:
a reading device for reading the update recording information from the plurality of recording media as received; and
a device for generating output image data that provides a view for displaying a state of allowance of update recording for the plurality of recording media as received, based on the update recording information as read, and prompting the user to specify the update recording.

13. A recording apparatus, which records one or more pieces of recording data on one recording medium selected among from a plurality of recording media supplied from an outside, and enables, when the recording medium has no available recording space, an update recording to be performed to conduct overwriting with new recording data in a recording area in which the recording data have currently been recorded, said recording apparatus comprising:
a recording device for recording the recording data on a recording medium;
a changing device for receiving a plurality of recording media supplied from an outside, selecting one of the plurality of recording media as received and replacing a first recording medium loaded in the recording device with a second recording medium as selected;
an input device for outputting a signal in accordance with a user's operation; and
a control device for generating, based on the signal output from the input device, set-specification information for specifying recording media which constitute a set of recording media in the plurality of received recording media, generating update recording information for specifying a recording medium which allows update recording, in the plurality of recording media as received, controlling the recording device and the changing device based on the set-specification information to record a part of the recording data on one of the set of recording media, and then continuously recording another part of the recording data, which follows said part of the recording data, on another recording medium of the set of recording media, controlling, when all of the set of recording media have no available recording space, the recording device and the changing device based on the update recording information to specify a recording medium, which allows update recording, in said set of recording media, and conducting overwriting with new recording data in a recording area of said recording medium as specified, in which the recording data have currently been recorded.

14. A recording apparatus comprising:
a recording device for recording recording data on a recording medium;
a changing device for receiving a plurality of recording media supplied from an outside, selecting one of the plurality of recording media as received and replacing a first recording medium loaded in the recording device with a second recording medium as selected;
an input device for outputting a signal in accordance with a user's operation; and
a control device for generating, based on the signal output from the input device, category information that indicates a category of the recording data to be recorded on each of the recording media as received and controlling the recording device to record the category information on the recording media.

15. The recording apparatus according to claim 14, further comprising:
a reading device for reading the category information from the plurality of recording media as received; and
a device for generating output image data that provides a view for displaying a category for each recording medium based on the category information as read and prompting a user to select the category of the recording data to be recorded.

16. The recording apparatus according to claim 15, wherein:
the control device identifies the category as selected, based on the signal output from the input device, and controls the recording device and the changing device to record the recording data on the recording medium with a same category as the category as selected.

17. A reproducing apparatus that enables sequential reproduction of image data from a plurality of recording media in which a sequence of divided image data and management information which specifies an order of reproduction have been recorded, comprising:
a reproducing device for reproducing the image data and the management information from a recording medium of the plurality of recording media;
a changing device for receiving the plurality of recording media supplied from an outside, selecting one of the plurality of recording media as received and replacing a first recording medium loaded in the recording device with a second recording medium as selected;
an input device for outputting a signal in accordance with a user's operation; and
a control device for controlling, when there is made a detection of specification of the sequential reproduction, the changing device and the reproducing device based on the signal output from the input device, to reproduce sequentially the recording media in the reproduction order, which is specified by the management information reproduced from the plurality of recording media as received.

18. The reproducing apparatus according to claim 17, further comprising:
a storage device for storing the image data output from the reproducing device and outputting the image data as stored, on a FIFO basis,
the control device writting, for a predetermined period of time before completion of replacement of the first recording medium, data on the storage device at a data write rate higher than a data read rate.

19. The reproducing apparatus according to claim 18, wherein;
the storage device has a storage capacity, which is larger than the product of (i) a period of time from a start of the replacement of the first recording medium to a time when the reproduction of the data from the second recording medium becomes possible and (ii) a data read rate of the storage device.

20. A method for controlling a recording apparatus, said recording apparatus that has an input device for outputting a signal in accordance with a user's operation and enables recording data to be dividedly recorded on recording media on which a set-specification information for specifying a set of recording media to be subjected to a sequential recording has previously been recorded, said method comprising:
a step of reading the set-specification information from a plurality of recording media supplied from an outside;
a step of displaying an image for prompting specification of the set of recording media to be subjected to the sequential recording, based on the set-specification information as read; and
a step of recording, after the set of recording media to be subjected to the sequential recording is specified by the input device, recording a part of the recording data on one of the set of recording media, and then continuously recording another part of the recording data, which follows said part of the recording data, on another recording medium of the set of recording media.

21. A method for controlling a recording apparatus, said recording apparatus that has an input device for outputting a signal in accordance with a user's operation and enables to record recording data on a recording medium in which there has previously been recorded an update recording information, which allows, when there is no available recording space, an update recording to be performed to conduct overwriting with new, recording data in a recording area in which the recording data have currently been recorded, said method comprising:
a step of reading the update recording information from a plurality of recording media supplied from an outside;
a step of displaying an image that indicates recording media of the plurality of recording media as received, which allow the update recording to be performed and prompts specification of a recording medium to be subjected to recording, based on the update recording information as read; and
a step of overwriting, after the recording medium to be subjected to the recording is specified by the input device, a recording area in which the recording data has first been recorded, with new recording data when the recording medium has no available recording space, in case where the recording medium as specified allows update recording.

22. A method of controlling a recording apparatus, said recording apparatus that has an input device for outputting a signal in accordance with a user's operation and enables recording data to be selectively recorded on a recording medium on which a category information, which indicates a category of a recorded content, has previously recorded, said method comprising:
a step of reading the category information from a plurality of recording medium supplied from an outside;
a step of displaying the category of the recorded content based on the category information as read and prompting specification of a category of recording data to be recorded; and
a step of selecting, after the category is specified by the input device, a recording medium with the same category as the specified one and recording the recording data on the recording medium.
